(19) United States
(12) Patent Application Publication
(10) Pub. No.: US 2025/0165855 A1
(43) Pub. Date: May 22, 2025

(54) SYSTEM AND METHOD FOR GENERATING RECOURSE PATHS WITH PRIVACY GUARANTEES

(71) Applicant: JPMorgan Chase Bank, N.A., New York, NY (US)

(72) Inventors: Sikha PENTYALA, Seattle, WA (US); Shubham SHARMA, Manhattan, NY (US); Sanjay KARIYAPPA, Mountain View, CA (US); Freddy LECUE, Mamaroneck, NY (US); Daniele MAGAZZENI, London (GB)

(73) Assignee: JPMorgan Chase Bank, N.A., New York, NY (US)

(21) Appl. No.: 18/517,211

(22) Filed: Nov. 22, 2023

(51) Int. Cl. G06N 20/00

(52) U.S. Cl. CPC G06N 20/00

(57) ABSTRACT

Various methods and processes, apparatuses/systems, and media for generating realistic multi-step recourse paths while preserving privacy of customers are disclosed. A processor trains an ML model by using the at least a first set training data; implements a data distribution sampling algorithm on the first set of training data to generate corresponding sampled data by partitioning the first set of training data into non-overlapping subsets with differentially private clustering; computes a plurality of cluster centers with differential privacy guarantees for each of said plurality of cluster centers; generates a graph that connects each cluster center with different weights between each cluster center; and automatically generates, for a data point that receives a negative outcome from the trained model, a recourse path with privacy guarantees based on a plurality of set points from the graph that provides shortest path to output a positive outcome.

### TECHNICAL FIELD

This disclosure generally relates to data processing, and, more particularly, to methods and apparatuses for implementing a platform, language, cloud, and database agnostic recourse path generating module configured to implement an end-to-end differentially private pipeline for generating realistic counterfactuals and recourse paths.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

When individuals are subject to adverse outcomes from Machine Learning models, providing a recourse path to help achieve a positive outcome may be desirable. Recent work has shown that counterfactual explanations—which might be used as a means of single-step recourse—may be vulnerable to privacy issues, putting an individuals' privacy at risk. Providing a sequential multi-step path for recourse may amplify this risk. Furthermore, simply adding noise to recourse paths found from existing methods may impact the realism and actionability of the path for an end-user.

For example, numerous financial systems, such as credit approval processes, are often driven by ML models to provide decisions. When users are adversely affected by these decisions, it may become crucial to offer transparent explanations. This also aligns with regulatory requirements like the Equal Credit Opportunity Act (ECOA), Fair Credit Reporting Act (FCRA), the ‘Right to Explanation’ in the European-Union General Data Protection Regulation (EU-GDPR), and the US Artificial Intelligence Bill of Rights. These explanations may be in the form of sequential steps to get preferred or favorable outcomes. Such recommended steps may be considered as providing algorithmic recourse to the affected user. Single-step recourses are often computed through counterfactual explanations, which may be a type of explanation that suggest the changes that might be made to the input to get a different decision. Recent work has shown that providing a single-step path may not be enough: a given recourse should constitute multistep changes toward a favorable outcome. Additionally, it may be important that such recourse paths should be realistic in nature (i.e., feasible and actionable) for it to be useful for the end-users. But providing a counterfactual explanation—a single-step recourse path—may prove to be challenging.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic recourse path generating module configured to implement an end-to-end differentially private pipeline for generating realistic counterfactuals and recourse paths (i.e., a set of actions via a set of changes to an input) by utilizing ML models, while preserving privacy data of customers used as training data, but the disclosure is not limited thereto.

For example, the present disclosure, through one or more of its various aspects, embodiments, and/or specific features or sub-components, provides, among other features, various systems, servers, devices, methods, media, programs, and platforms for implementing a platform, language, cloud, and database agnostic recourse path generating module configured to address privacy issues when generating realistic recourse paths based on instance-based counterfactual explanations, and provide an end-to-end privacy preserving pipeline that can provide realistic recourse paths. The pipeline, according to exemplary embodiments, utilizes Differentially Private (DP) clustering to represent non-overlapping subsets of the private dataset. These DP cluster centers are then used to generate recourse paths by forming a graph with cluster centers as the nodes, so that the recourse path generating module can generate private and realistic-feasible and actionable-recourse paths. The recourse path generating module may be configured to empirically evaluate this approach on finance datasets and compare it to simply adding noise to data instances, and to using DP synthetic data, to generate the graph, but the disclosure is not limited thereto.

According to exemplary embodiments, a method for generating realistic multi-step recourse paths with privacy guarantees by utilizing one or more processors along with allocated memory and a machine learning model is disclosed. The method may include: receiving a first set of training data that is usable for training a machine learning model: training the machine learning model by using the at least the first set training data; implementing a data distribution sampling algorithm on the first set of training data to generate corresponding sampled data by partitioning the first set of training data into non-overlapping subsets with differentially private clustering: computing a plurality of cluster centers with differential privacy guarantees for each of said plurality of cluster centers; generating a graph that connects each cluster center with different weights between each cluster center; and automatically generating, for a data point that receives a negative outcome from the trained model, a recourse path with privacy guarantees based on a plurality of set points from the graph that provides shortest path to output a positive outcome.

According to exemplary embodiments, the weights between each cluster center may be defined by one or more of the following: distance thresholds between cluster centers, constraints specified for graph edges, and data density, but the disclosure is not limited thereto.

According to exemplary embodiments, the plurality of cluster centers generated in the computing step may represent a private version of the training data.

According to exemplary embodiments, the method may further include: validating the generated recourse path by utilizing existing and new metrics, wherein the metrics include distance between points in the recourse path, density of points in the recourse path, and path length.

According to exemplary embodiments, in generating the graph, the method may further include: connecting each cluster center: updating the weights to every other cluster based on distance threshold parameter, constraints for features, and density of data; and generating the graph based on the updated weights.

According to exemplary embodiments, the method may further include: implementing differentially private k-means or differentially private maximum mean discrepancy algorithm on the sampled data to compute the plurality of cluster centers.

According to exemplary embodiments, the machine learning model may include one or more of the following models: decision tree, ensemble trees, logistic regression, neural network architectures, and predictive model, but the disclosure is not limited thereto.

According to exemplary embodiments, a system for generating realistic multi-step recourse paths with privacy guarantees is disclosed. The system may include: a processor; and a memory operatively connected to the processor via a communication interface, the memory storing computer readable instructions, when executed, may cause the processor to: receive a first set of training data that is usable for training a machine learning model: train the machine learning model by using the at least the first set training data: implement a data distribution sampling algorithm on the first set of training data to generate corresponding sampled data by partitioning the first set of training data into non-overlapping subsets with differentially private clustering: compute a plurality of cluster centers with differential privacy guarantees for each of said plurality of cluster centers: generate a graph that connects each cluster center with different weights between each cluster center; and automatically generate, for a data point that receives a negative outcome from the trained model, a recourse path with privacy guarantees based on a plurality of set points from the graph that provides shortest path to output a positive outcome.

According to exemplary embodiments, the processor may be further configured to: validate the generated recourse path by utilizing existing and new metrics, wherein the metrics include distance between points in the recourse path, density of points in the recourse path, and path length.

According to exemplary embodiments, in generating the graph, the processor may be further configured to: connect each cluster center: update the weights to every other cluster based on distance threshold parameter, constraints for features, and density of data; and generate the graph based on the updated weights.

According to exemplary embodiments, the processor may be further configured to: implement differentially private k-means or differentially private maximum mean discrepancy algorithm on the sampled data to compute the plurality of cluster centers.

According to exemplary embodiments, a non-transitory computer readable medium configured to store instructions for generating realistic multi-step recourse paths with privacy guarantees is disclosed. The instructions, when executed, may cause a processor to perform the following: receiving a first set of training data that is usable for training a machine learning model: training the machine learning model by using the at least the first set training data: implementing a data distribution sampling algorithm on the first set of training data to generate corresponding sampled data by partitioning the first set of training data into non-overlapping subsets with differentially private clustering: computing a plurality of cluster centers with differential privacy guarantees for each of said plurality of cluster centers: generating a graph that connects each cluster center with different weights between each cluster center; and automatically generating, for a data point that receives a negative outcome from the trained model, a recourse path with privacy guarantees based on a plurality of set points from the graph that provides shortest path to output a positive outcome.

According to exemplary embodiments, the instructions, when executed, may cause the processor to further perform the following: validating the generated recourse path by utilizing existing and new metrics, wherein the metrics include distance between points in the recourse path, density of points in the recourse path, and path length.

According to exemplary embodiments, in generating the graph, the instructions, when executed, may cause the processor to further perform the following: connecting each cluster center: updating the weights to every other cluster based on distance threshold parameter, constraints for features, and density of data; and generating the graph based on the updated weights.

According to exemplary embodiments, the instructions, when executed, may cause the processor to further perform the following: implementing differentially private k-means or differentially private maximum mean discrepancy algorithm on the sampled data to compute the plurality of cluster centers.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic recourse path generating module configured to implement an end-to-end differentially private pipeline for generating realistic counterfactuals and recourse paths in accordance with an exemplary embodiment.

FIG. 2 illustrates an exemplary diagram of a network environment with a platform, language, database, and cloud agnostic recourse path generating device in accordance with an exemplary embodiment.

FIG. 3 illustrates a system diagram for implementing a platform, language, database, and cloud agnostic recourse path generating device having a platform, language, database, and cloud agnostic recourse path generating module in accordance with an exemplary embodiment.

FIG. 4 illustrates a system diagram for implementing a platform, language, database, and cloud agnostic recourse path generating module of FIG. 3 in accordance with an exemplary embodiment.

FIG. 5 illustrates an exemplary recourse path generated by the platform, language, database, and cloud agnostic recourse path generating module of FIG. 4 in accordance with an exemplary embodiment.

FIG. 6 illustrates an exemplary flow chart of a process implemented by the platform, language, database, and cloud agnostic recourse path generating module of FIG. 4 for generating realistic counterfactuals and recourse paths in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

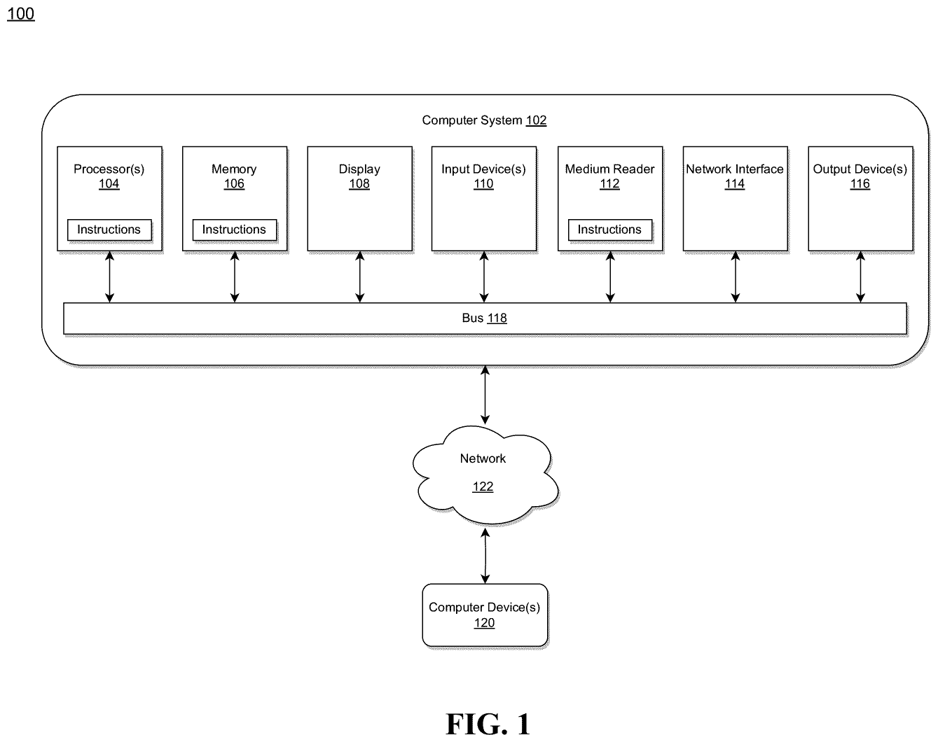

FIG. 1 is an exemplary system 100 for use in implementing a platform, language, database, and cloud agnostic recourse path generating module configured to implement an end-to-end differentially private pipeline for generating realistic counterfactuals and recourse paths in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the recourse path generating module implemented by the system 100 may be platform, language, database, and cloud agnostic that may allow for consistent easy orchestration and passing of data through various components to output a desired result regardless of platform, browser, language, database, and cloud environment. Since the disclosed process, according to exemplary embodiments, is platform, language, database, browser, and cloud agnostic, the recourse path generating module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

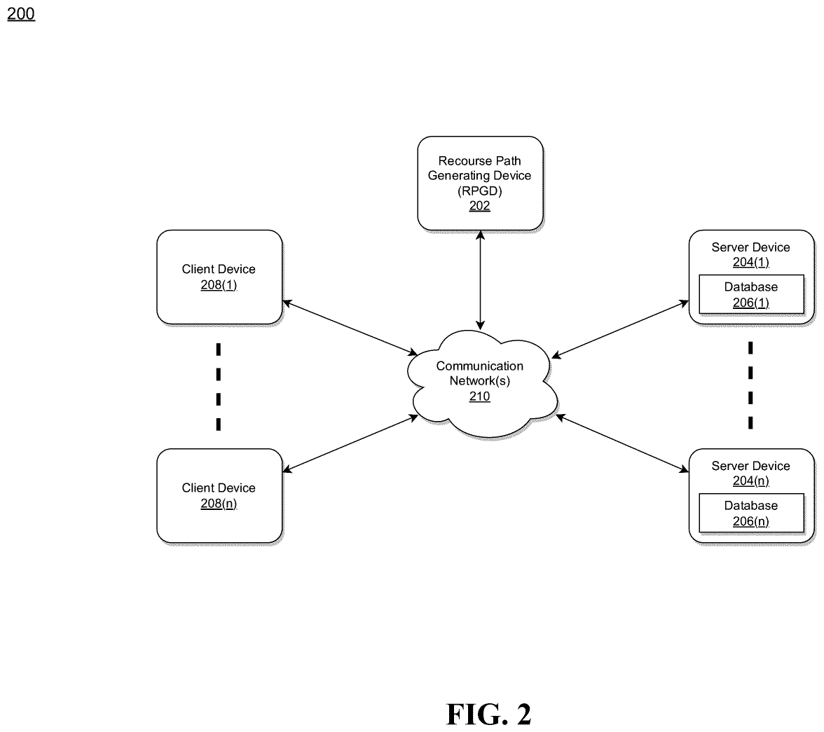

Referring to FIG. 2, a schematic of an exemplary network environment 200 for implementing a language, platform, database, and cloud agnostic recourse path generating device (RPGD) of the instant disclosure is illustrated.

According to exemplary embodiments, the above-described problems associated with conventional tools may be overcome by implementing an RPGD 202 as illustrated in FIG. 2 that may be configured for implementing a platform, language, database, and cloud agnostic recourse path generating module configured to implement an end-to-end differentially private pipeline for dynamically and automatically generating realistic counterfactuals and recourse paths, but the disclosure is not limited thereto.

The RPGD 202 may have one or more computer system 102s, as described with respect to FIG. 1, which in aggregate provide the necessary functions.

The RPGD 202 may store one or more applications that can include executable instructions that, when executed by the RPGD 202, cause the RPGD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RPGD 202 itself, may be located in virtual server(s) running in a cloud-based computing environment rather than being tied to one or more specific physical network computing devices. Also, the application(s) may be running in one or more virtual machines (VMs) executing on the RPGD 202. Additionally, in one or more embodiments of this technology, virtual machine(s) running on the RPGD 202 may be managed or supervised by a hypervisor.

In the network environment 200 of FIG. 2, the RPGD 202 is coupled to a plurality of server devices 204(1)-204(n) that hosts a plurality of databases 206(1)-206(n), and also to a plurality of client devices 208(1)-208(n) via communication network(s) 210. A communication interface of the RPGD 202, such as the network interface 114 of the computer system 102 of FIG. 1, operatively couples and communicates between the RPGD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RPGD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RPGD 202 may be a standalone device or integrated with one or more other devices or apparatuses, such as one or more of the server devices 204(1)-204(n), for example. In one particular example, the RPGD 202 may be hosted by one of the server devices 204(1)-204(n), and other arrangements are also possible. Moreover, one or more of the devices of the RPGD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RPGD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the RPGD 202 that may efficiently provide a platform for implementing a platform, language, database, and cloud agnostic recourse path generating module configured to implement an end-to-end differentially private pipeline for dynamically and automatically generating realistic counterfactuals and recourse paths, but the disclosure is not limited thereto.

The client devices 208(1)-208(n) may run interface applications, such as standard web browsers or standalone client applications, which may provide an interface to communicate with the RPGD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the RPGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the RPGD 202, the server devices 204(1)-204(n), or the client devices 208(1)-208(n), for example, may be configured to operate as virtual instances on the same physical machine. For example, one or more of the RPGD 202, the server devices 204(1)-204(n), or the client devices 208(1)-208(n) may operate on the same physical device rather than as separate devices communicating through communication network(s) 210. Additionally, there may be more or fewer RPGDs 202, server devices 204(1)-204(n), or client devices 208(1)-208(n) than illustrated in FIG. 2. According to exemplary embodiments, the RPGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

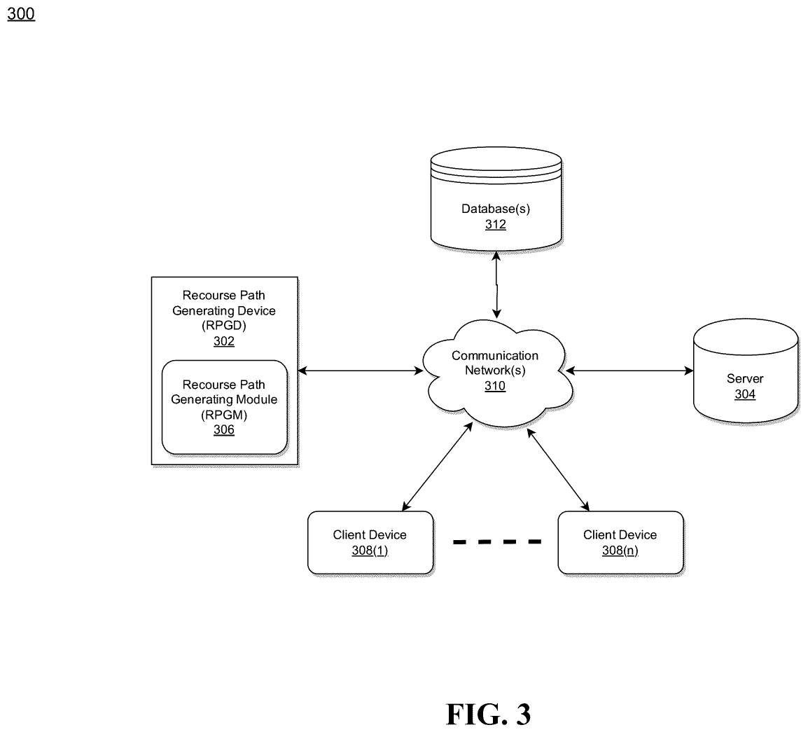

FIG. 3 illustrates a system diagram for implementing a platform, language, and cloud agnostic RPGD having a platform, language, database, and cloud agnostic recourse path generating module (RPGM) in accordance with an exemplary embodiment.

As illustrated in FIG. 3, the system 300 may include an RPGD 302 within which an RPGM 306 is embedded, a server 304, a database(s) 312, a plurality of client devices 308(1) . . . 308(n), and a communication network 310.

According to exemplary embodiments, the RPGD 302 including the RPGM 306 may be connected to the server 304, and the database(s) 312 via the communication network 310. The RPGD 302 may also be connected to the plurality of client devices 308(1) . . . 308(n) via the communication network 310, but the disclosure is not limited thereto. The database(s) 312 may include rule database.

According to exemplary embodiment, the RPGD 302 is described and shown in FIG. 3 as including the RPGM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the RPGM 306 may be configured to receive real-time feed of data from the plurality of client devices 308(1) . . . 308(n) and secondary sources via the communication network 310.

As may be described below, the RPGM 306 may be configured to: receive a first set of training data that is usable for training a machine learning model: train the machine learning model by using the at least the first set training data: implement a data distribution sampling algorithm on the first set of training data to generate corresponding sampled data by partitioning the first set of training data into non-overlapping subsets with differentially private clustering: compute a plurality of cluster centers with differential privacy guarantees for each of said plurality of cluster centers: generate a graph that connects each cluster center with different weights between each cluster center; and automatically generate, for a data point that receives a negative outcome from the trained model, a recourse path with privacy guarantees based on a plurality of set points from the graph that provides shortest path to output a positive outcome, but the disclosure is not limited thereto.

The plurality of client devices 308(1) . . . 308(n) are illustrated as being in communication with the RPGD 302. In this regard, the plurality of client devices 308(1) . . . 308(n) may be “clients” (e.g., customers) of the RPGD 302 and are described herein as such. Nevertheless, it is to be known and understood that the plurality of client devices 308(1) . . . 308(n) need not necessarily be “clients” of the RPGD 302, or any entity described in association therewith herein. Any additional or alternative relationship may exist between either or both of the plurality of client devices 308(1) . . . 308(n) and the RPGD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the RPGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The RPGD 302 may be the same or similar to the RPGD 202 as described with respect to FIG. 2, including any features or combination of features described with respect thereto.

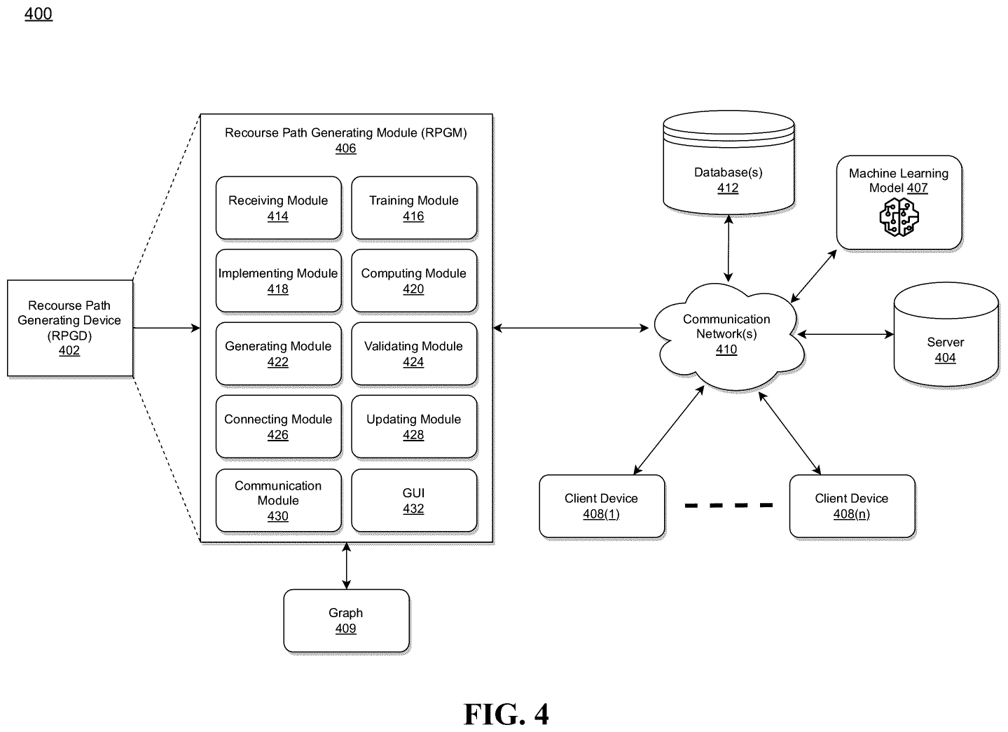

FIG. 4 illustrates a system diagram for implementing a platform, language, database, and cloud agnostic RPGM of FIG. 3 in accordance with an exemplary embodiment.

According to exemplary embodiments, the system 400 may include a platform, language, database, and cloud agnostic RPGD 402 within which a platform, language, database, and cloud agnostic RPGM 406 is embedded, a server 404, database(s) 412, an ML model 407, and a communication network 410. According to exemplary embodiments, server 404 may comprise a plurality of servers located centrally or located in different locations, but the disclosure is not limited thereto.

According to exemplary embodiments, the RPGD 402 including the RPGM 406 may be connected to the server 404, the ML model 407, and the database(s) 412 via the communication network 410. The RPGD 402 may also be connected to the plurality of client devices 408(1)-408(n) via the communication network 410, but the disclosure is not limited thereto. The RPGM 406, the server 404, the plurality of client devices 408(1)-408(n), the database(s) 412, the communication network 410 as illustrated in FIG. 4 may be the same or similar to the RPGM 306, the server 304, the plurality of client devices 308(1)-308(n), the database(s) 312, the communication network 310, respectively, as illustrated in FIG. 3.

According to exemplary embodiments, the ML model 7 may include one or more of the following models: decision tree, ensemble trees, logistic regression, neural network architectures, predictive model, etc., but the disclosure is not limited thereto.

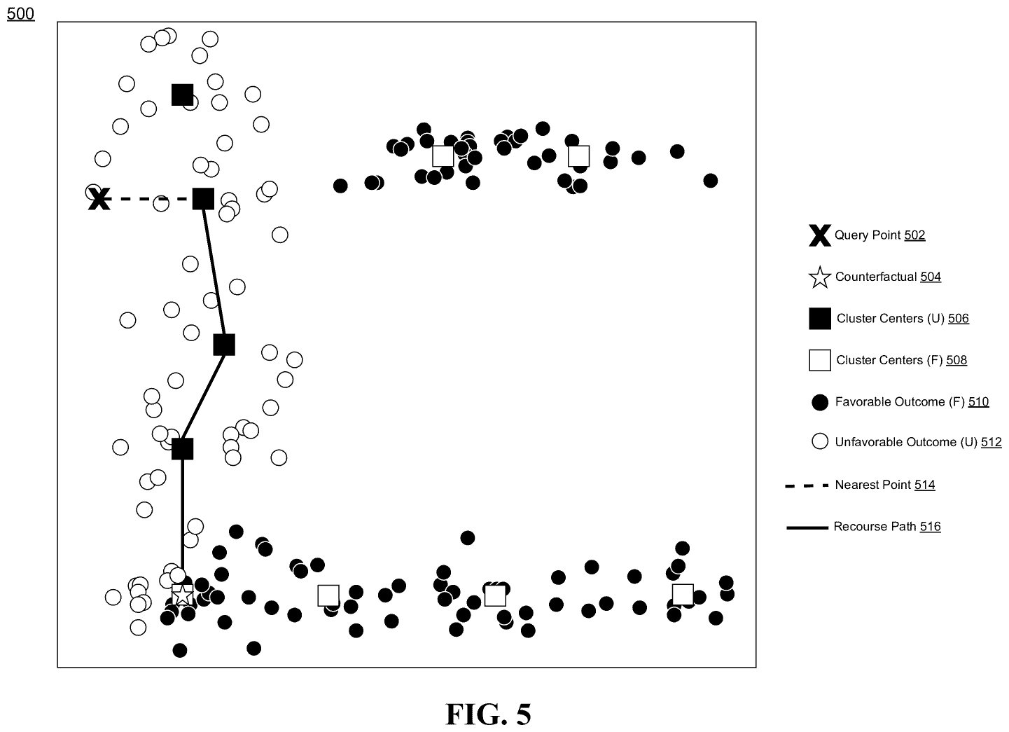

According to exemplary embodiments, the RPGM 406 implements DP clustering to represent non-overlapping subsets of the private dataset. These DP cluster centers are then used to generate recourse paths by forming a graph 409 (see, e.g., FIG. 5, illustrating an exemplary graph 500 that shows a recourse path 516) with cluster centers as the nodes, so that the RPGM 406 can generate realistic-feasible and actionable-recourse paths while preserving individuals' privacy. The RPGM 406, according to exemplary embodiments, may empirically evaluate this approach on finance datasets and compare it to simply adding noise to data instances, and to using DP synthetic data, to generate the graph 409, thereby generating paths that are private and realistic.

Details of the RPGM 406 is provided below with corresponding modules that may be configured to, in combination, results in executing an end-to-end privacy preserving pipeline that automatically and dynamically provides realistic recourse paths as illustrated in FIG. 5.

According to exemplary embodiments, as illustrated in FIG. 4, the RPGM 406 may include a receiving module 414, a training module 416, an implementing module 418, a computing module 420, a generating module 422, a validating module 424, a connecting module 426, an updating module 428, a communication module 430, and a GUI 432. According to exemplary embodiments, interactions and data exchange among these modules included in the RPGM 406 provide the advantageous effects of the disclosed invention. Functionalities of each module of FIG. 4 may be described in detail below with reference to FIGS. 4-6.

According to exemplary embodiments, each of the receiving module 414, training module 416, implementing module 418, computing module 420, generating module 422, validating module 424, connecting module 426, updating module 428, and the communication module 430 of the RPGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, training module 416, implementing module 418, computing module 420, generating module 422, validating module 424, connecting module 426, updating module 428, and the communication module 430 of the RPGM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the receiving module 414, training module 416, implementing module 418, computing module 420, generating module 422, validating module 424, connecting module 426, updating module 428, and the communication module 430 of the RPGM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the RPGM 406 of FIG. 4 may also be implemented by Cloud based deployment.

According to exemplary embodiments, each of the receiving module 414, training module 416, implementing module 418, computing module 420, generating module 422, validating module 424, connecting module 426, updating module 428, and the communication module 430 of the RPGM 406 of FIG. 4 may be called via corresponding API, but the disclosure is not limited thereto.

According to exemplary embodiments, the process implemented by the RPGM 406 may be executed via the communication module 430 and the communication network 410, which may comprise plural networks as described above. For example, in an exemplary embodiment, the various components of the RPGM 406 may communicate with the server 404, and the database(s) 412 via the communication module 430 and the communication network 410 and the results (i.e., generated graph and paths) may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

For example, according to exemplary embodiments, the receiving module 414 may be configured to receive a first set of training data that is usable for training an ML model 407. The training module 416 may be configured to train the ML model 407 by using the at least the first set training data. The implementing module 418 may be configured to: implement a data distribution sampling algorithm on the first set of training data to generate corresponding sampled data by partitioning the first set of training data into non-overlapping subsets with differentially private clustering.

According to exemplary embodiments, the RPGM 406 may be configured to apply a first pre-processing step of private model training and computation. The first set of training data received by the receiving module 414 may include input raw data R: X1 (A=0, B=1, C=8, D=9); X2 (A=0, B=30, C=1, D=2); X3 (A=0, B=3, C=8, D=−31); . . . ; and Xn (A=7, B=2, C=6, D=5). According to exemplary embodiments, the first set of training data (i.e., input raw data R) may include various types of application data (i.e., car loan, mortgage loan, student loan, credit card application, etc., but the disclosure is not limited thereto).

According to exemplary embodiments, the RPGM 406 may be configured to apply a second pre-processing step of applying data distribution sampling algorithm/strategy onto the first input raw data R to generate corresponding sampled dataset. According to exemplary embodiments, data distribution sampling algorithm may include: strategy 1: selecting 3 random points: strategy 2: selecting 3 with feature A=0; strategy 3: selecting the first 3, etc., but the disclosure is not limited thereto.

For example, the first sampled dataset after applying the sampling algorithm onto the first input raw data R may include: X′1 (A=1, B=6, C=6, D=7): X″2 (A=2, B=11, C=7, D=3): X″3 (A=6, B=9, C=8, D=−1).

According to exemplary embodiments, accuracy target could be manifested by statistic metrics for measuring quality of prediction such as Mean Squared Error (MSE). The MSE measures how close a regression line is to a set of data points. According to exemplary embodiments, target accuracy may be 0.8 (value in interval 0 and 1). Accuracy score also could be manifested by statistic metrics for measuring quality of prediction such as MSE. According to exemplary embodiments, accuracy score may be 0.9 (value in interval 0 and 1).

During pre-processing step of private model training (i.e., ML 407 training) and computation, the training module 416 may be configured to learn model representative of input raw data R, e.g., predictive model with regularized for differential privacy. According to exemplary embodiments, privacy budget may correspond to how much randomness is added for ensuring privacy. According to exemplary embodiments, computed privacy budget for training the ML 407 may be 10. According to exemplary embodiments, the ML model 407 may include one or more of the following models: decision tree, ensemble trees, logistic regression, neural network architectures, and predictive model, but the disclosure is not limited thereto. The RPGM 406 may utilize the ML model 407 for predictions and for which recourse paths are generated.

According to exemplary embodiments, the computing module 420 may be configured to compute a plurality of cluster centers with differential privacy guarantees for each of the plurality of cluster centers. The generating module 422 may be configured to generate a graph 409 that connects each cluster center with different weights between each cluster center; and automatically generate, for a data point that receives a negative outcome from the trained model (i.e., trained ML model 407, a recourse path with privacy guarantees based on a plurality of set points from the graph that provides shortest path to output a positive outcome).

For example, FIG. 5 illustrates an exemplary graph 500 generated by the RPGM 406 of FIG. 4 in accordance with an exemplary embodiment. FIG. 5 illustrates query point 502, counterfactual 504, cluster centers (unfavorable) 506, cluster centers (favorable) 508, favorable outcome 510, unfavorable outcome 512, nearest point 514, and a generated recourse path 516.

For example, the computing module 420 may be configured to compute N cluster centers with differential privacy guarantees for each of the cluster centers. According to exemplary embodiments, the plurality of cluster centers generated in the computing step may represent a private version of the training data. For example, for CSR′1 . . . , CSR′n, differentially private cluster center may include CX′1 (A=1, B=8, C=7, D=1), . . . . CX″n (A=2, B=10, C=8, D=4).

According to exemplary embodiments, RPGM 406 may be configured to implement differentially private k-means or differentially private maximum mean discrepancy algorithm on the sampled data to compute the plurality of cluster centers. For example, for each data point X, the RPGM 406 implements the following processes: find the closest private cluster center from the step of generating the graph 500; for this pint, find the shortest path in the graph 500 that returns a point with a positive outcome; add the nodes (cluster centers in this graph 500) to recourse path; and return the recourse path 516. For example, for input point, the exemplary recourse path 516 may include: X′1→CSR′4→CSR′7; X′2→CSR′5→CSR′8; . . . , X′n→CSR′1→CSR′4→CSR′6.

According to exemplary embodiments, the weights between each cluster center may be defined by one or more of the following: distance thresholds between cluster centers, constraints specified for graph edges, and data density, but the disclosure is not limited thereto.

According to exemplary embodiments, the validating module 424 may be configured to validate the generated recourse path 516 by utilizing existing and new metrics. The metrics may include distance between points in the recourse path 516, density of points in the recourse path 516, and path length.

According to exemplary embodiments, in generating the graph 500, the connecting module 426 may be configured to connect each cluster center. The updating module 428 may be configured to update the weights to every other cluster based on distance threshold parameter, constraints for features, and density of data. And the generating module 422 may be configured to generate the graph 500 based on the updated weights.

According to exemplary embodiments, the privacy-preserving pipeline implemented by the RPGM 406 for generating realistic recourse paths (i.e., 516 as illustrated in FIG. 5) for an unlimited number of query instances while providing privacy guarantees to the individuals in the training dataset. The RPGM 406 implemented differentially private clustering algorithm to show that forming a graph 500 on differentially private cluster centers can provide realistic recourse paths. The RPGM 406 empirically analyzed the impact of privacy on the realism of the recourse path for the disclosed approach and compared it to the baseline solutions that use synthetic training data and DP training data.

As mentioned earlier, counterfactual explanations have been popularly considered as a means of one-step recourse and are one of the ways to explain the predictions of a model. For an input instance Z and model f, the conventional formulation considers counterfactuals to be the smallest changes Δ required in the input i.e., Z*=Z+Δ to change the prediction of the model such that f(Z)≠f(Z*). The recourse path P generated by conventional approach consists of a single-step change from Z to Z*. This simple single-step scheme can produce counterfactuals/recourse paths that are unrealistic, degrading the utility of recourse.

The notion of DP disclosed herein guarantees plausible deniability regarding an instance being present in a dataset, hence providing privacy guarantees. Consider two neighboring datasets D and D′ that differ in a single instance, i.e., D′ can be obtained either by adding or removing an instance from D or vice-versa (assuming that each entry in the dataset is independent of other instances). A differentially private randomized algorithm A ensures that it generates a similar output probability distribution on D and D′. Formally, a randomized algorithm A is called (ϵ, δ)−DP if for all pairs of neighboring sets D and D′, and for all subsets O of A's range,

$$P ( 𝒜 ( D ) ∈ O ) \leq {e}^{∈} \cdot P ( 𝒜 ( {D}^{′} ) ∈ O ) + δ \qquad ( 1 )$$

where ϵ is the privacy budget or privacy loss and δ is the probability of violation of privacy. The smaller these values, the stronger the privacy guarantees. The above description of the DP notion is under the global model which assumes that a trusted curator exists who has access to D.

According to exemplary embodiments, the RPGM 406 may be configured to solve the following problem.

Consider a private dataset D with/training samples and Dᵢ=<X=(X^{C}ᵢ, X^{O}ᵢ), yᵢ> representing the i^{th} training sample in D, where X^{C}ᵢ is the set of nc continuous feature values, X^{O}ᵢ is the set of no categorical feature values and yᵢ is the value of a class label in Y. The data holder publishes a black-box machine learning model f: R^{nc+no}→Y trained on D, which outputs only the predicted label. For a query instance Z that receives an unfavorable outcome from the model, the data holder uses an explanation algorithm ø (f, D) to provide counterfactual Z* that produces a favorable outcome and a recourse path P from Z to Z*. P contains a sequence of points Z₁, Z₂, . . . , Zₚ with Zₚ=Z*, such that each point in P suggests incremental changes in the attributes towards the favorable outcome. The RPGM 406 implemented a method that generates realistic counterfactuals (Z*) and recourse paths (P) while providing (ϵ, δ)−DP for the training dataset D.

According to exemplary embodiments, during training phase, the pipeline outlined in an algorithm to publish privacy-preserving graph and candidate counterfactuals as implemented by the RPGM 406 may include the following main steps:

A) Train a DP ML model f on D with a privacy budget of (ϵ_{f}, δ_{f}). Publish f as a black-box model that outputs the value of predict( ) only. Any number of queries can be made on f while preserving the privacy of D under (ϵ_{f}, δ_{f})−DP guarantees.

B) Run an unsupervised clustering algorithm to partition D into K non-overlapping subsets D⁽¹⁾, D⁽²⁾, . . . , D^{(k)}, . . . , D^{(K)} with (ϵₖ, δₖ)−DP guarantees. Each subset, D^{(k)}, is represented by its cluster center Cₖ, which is equivalent to the DP representation of the subset.

C) Construct a graph G=(V, E) where V is the set of cluster centers C={Cₖ|kε{1 . . . . K}}. The nodes V are connected by an edge if they do not violate constraints thus providing actionability. The value of weights of the edges is computed based on the distance between the nodes and their density scoring given by the density estimate of C. G is published with (ϵₖ, δₖ)−DP due to post processing property.

According to exemplary embodiments, during training phase, the pipeline outlined in another algorithm to get privacy-preserving recourse as implemented by the RPGM 406 may include input data as Query instance Z, published information f( ), G and Z_{CF} favorable outcome y,distance function d( ); and output data as P and Z*.

This provides closeness to data manifold and feasibility. To get closer to the training data D or training data manifold, one could also opt for computing the weights based on the density estimate of D by publishing the privacy-preserving density estimate on D.

D) Given the favorable outcome y, get a set of candidate counterfactuals Z_{CF}⊂V such that for each Zₖ∈Z_{CF}, f(Zₖ)=y. Publish Z_{CF}.

The above process is equivalent to publishing the explanation algorithm ϕ(f, G) under (ϵ_{f}+ϵₖ, δ_{f}+δₖ)−DP guarantees due to sequential composition.

Description of Step 1. It is assumed that a DP ML model (i.e., ML model 407) has been trained and tuned to obtain desired utility. To make the ML model end-to-end differentially private, the RPGM 406 may be configured to make any preprocessing steps on the dataset also differentially private. It may be assumed domain knowledge for feature preprocessing as one does in an empirical analysis or perform privacy-preserving feature preprocessing using Randomized Response or Laplace or Gaussian Mechanisms.

Description of Step 2. The RPGM 406 may be configured to partition D into clusters (non-overlapping subsets) such that their cluster centers represent the data manifold of D. The RPGM 406 may be configured to employ a privacy-preserving clustering algorithm which ensures convergence within a specified privacy budget per iteration. The key idea is adding bounded noise to the cluster centers using the exponential mechanism during Lloyd's k-means clustering. First, random points are chosen as initial centers C₀. Each Dᵢ is then assigned to the nearest center Cₖ on l2 distance. Then, for each cluster Dₖ at the tₜₕ iteration, a convergent zone is created around the current Cₖ^{t} and previous centers C^{t-1}ₖ. Subzones are formed in these zones using k-means. A subzone is sampled based on number of data points the subzones contain. Next, a data point is sampled from the sampled subzone using the exponential mechanism as the new cluster center Cₖ^{t+1}. The exponential mechanism uses distance as the scoring function with a sensitivity of 1. After the algorithm converges, Laplace noise is added to the count of training data points in each cluster and then mean is computed using the DP counts.

According to exemplary embodiments, to get a counterfactual explanation for a given query instance Z, the RPGM 406 first gets the nearest node Z₁ to Z defined by the given distance function such that Z₁∈G, f(Z₁)≠y. The RPGM 406 then gets the shortest distances between Z and candidates in Z_{CF} The candidate Z* with the minimum shortest distance is the privacy-preserving counterfactual and the shortest path from Z₁ to Z* is the privacy-preserving recourse path P suggested along the data manifold. All points Zᵢ in P except Z* satisfy f(Zᵢ)≠y. As the ϕ(f, G) is published, any number of counterfactuals explanations and recourse paths can be queried where the answers to the queries provide (ϵf+ϵₖ, δ_{f}+δₖ)−DP guarantees due to the post-processing property of DP.

According to exemplary embodiments, datasets for training the ML model 407 may include training samples and test sample. For example, the task is to determine whether a person makes over 50K a year. The RPGM 406 considers ‘age’, ‘education num’, ‘capital-gain’, ‘capital-loss’, ‘hours-per-week’ as predictors for this task. The RPGM 406 then samples about 2000 training data points to construct graph G. The training module 416 may be configured to train a DP logistic regression model for each of the datasets on the complete training datasets. Continuous attributes are scaled using a min-max scaler, assuming a prior knowledge of the minimum and maximum values for each feature set to bound the sensitivity of each feature.

The RPGM 406 may be configured to evaluate the efficacy of the differentially private recourse path by considering various distance measures and the quality of recourse. The RPGM 406 may consider a recourse path feasible if it passes through the denser region of the data manifold and lies closer to the data manifold as illustrated in FIG. 5. according to exemplary embodiments, the RPGM 406 may be configured to evaluate the realism of the recourse path using the metrics described below.

PDensity: This metric gives the measure of the total loglikelihood of the sample points constituting the recourse path under the density estimate of D. Let ρ^{D} be the density estimate of D and ρ^{D}(x) denote the log likelihood of the sample x under density estimate ρ^{D}. For a recourse path P containing a sequence of points Z₁, Z₂, . . . , Zₚ with Zₚ=Z*, PDensity is given by:

$$PDensity = \frac{{\sum }_{i = 1}^{p} {p}^{D} ( {Z}_{i} )}{p} \qquad ( 2 )$$

PDistanceManifold: This metric gives the distance of each step in P from the training dataset. A Nearest Neighbor (NN) algorithm is trained on the training dataset and is used to get the l1-distance between Z, and its nearest neighbor in training dataset.

$$PDistanceManifold = \frac{{\sum }_{i = 1}^{p} {d}_{1} ( {Z}_{i} , NN ( D , {Z}_{i} ) )}{p} \qquad ( 3 )$$

The RPGM 406 also considers average distance metrics for the recourse path. For any given distance function d(.,.), the computing module 420 may be configured to compute average distance of the recourse path P as PDistance given by:

$$PDistance = \frac{{\sum }_{i = 1}^{p - 1} d ( {Z}_{i} , {Z}_{i + 1} ) + d ( Z , {Z}_{1} ) )}{p} \qquad ( 4 )$$

The RPGM 406 utilizes L0 as d(.,.) in Eqn. 4 to report the sparsity of the recourse path and refer to it as PL0. L1 and L2 are used as d(.,.) in Eqn. 4 to report the proximity of the recourse path and refer to them as PL1 and PL2 respectively.

The RPGM 406 may additionally report the quality of CFE (Z*) in terms of its sparsity (with respect to the original point) and its robustness for flipped prediction. According to exemplary embodiments, the RPGM 406 may measure the robustness of the CFE by measuring the closeness of CFE to the favorable outcome data manifold (yNN) by counting the instances in its neighborhood with the same outcome. The RPGM 406 may also measure the sparsity of the CFE by computing the number of feature changes not necessary for change in prediction (Redundancy). While the primary metric of focus for us is based on feasibility, each of the above measures can help inform on the actionability (the actionability of the recourse path is inherent to the proposed solution as the graph can be constructed with constraints) and feasibility of the recourse path in different ways.

The pipeline implemented by the RPGM 406 considers the shortest path returned by the algorithm as the recourse path. It is noted that multiple recourse paths may be returned by the RPGM 406 to satisfy diversity by returning the second, third, and fourth shortest paths as multiple recourses. Additional constraints may also be employed by the RPGM 406 while generating these paths to see changes in different features. The advantage of a privacy-published graph is that a synthetic node or a noisy new observed data point can be added at any time to improve the quality of generated recourse paths and additional constraints may be imposed to modify the graph 500 as illustrated in FIG. 5.

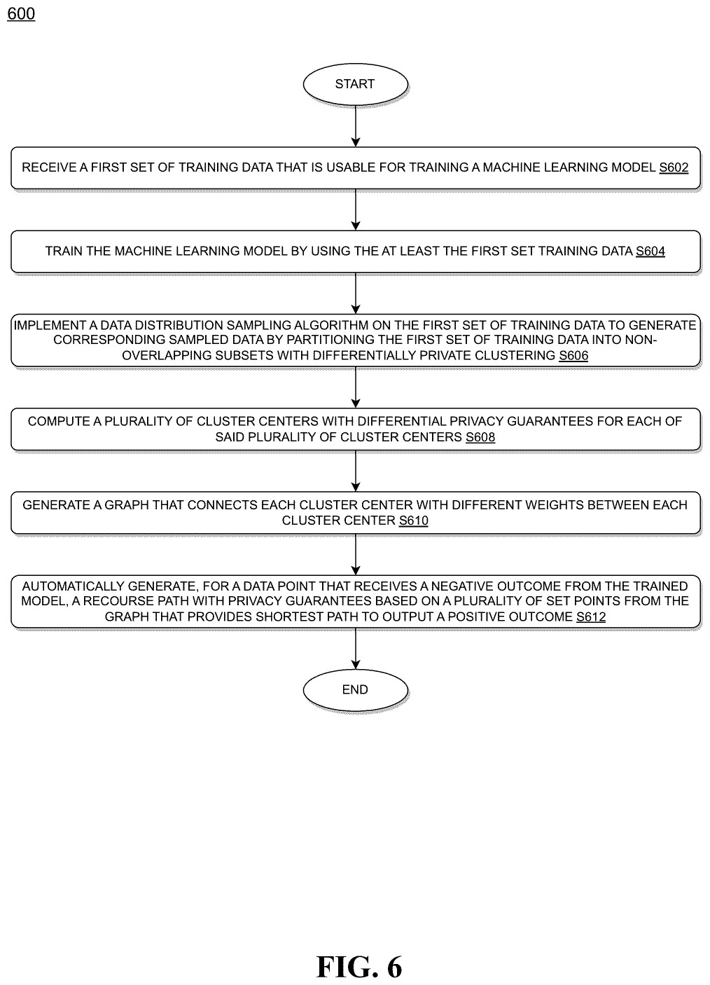

FIG. 6 illustrates an exemplary flow chart of a process 600 implemented by the platform, language, database, and cloud agnostic RPGM 406 of FIG. 4 for generating realistic multi-step recourse paths with privacy guarantees in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include receiving a first set of training data that is usable for training a machine learning model.

At step S604, the process 600 may include training the machine learning model by using the at least the first set training data.

At step S606, the process 600 may include implementing a data distribution sampling algorithm on the first set of training data to generate corresponding sampled data by partitioning the first set of training data into non-overlapping subsets with differentially private clustering.

At step S608, the process 600 may include computing a plurality of cluster centers with differential privacy guarantees for each of said plurality of cluster centers.

At step S610, the process 600 may include generating a graph that connects each cluster center with different weights between each cluster center.

At step S612, the process 600 may include automatically generating, for a data point that receives a negative outcome from the trained model, a recourse path with privacy guarantees based on a plurality of set points from the graph that provides shortest path to output a positive outcome.

According to exemplary embodiments, in the process 600, the weights between each cluster center may be defined by one or more of the following: distance thresholds between cluster centers, constraints specified for graph edges, and data density, but the disclosure is not limited thereto.

According to exemplary embodiments, in the process 600, the plurality of cluster centers generated in the computing step may represent a private version of the training data.

According to exemplary embodiments, the process 600 may further include: validating the generated recourse path by utilizing existing and new metrics, wherein the metrics include distance between points in the recourse path, density of points in the recourse path, and path length.

According to exemplary embodiments, in generating the graph, the process 600 may further include: connecting each cluster center: updating the weights to every other cluster based on distance threshold parameter, constraints for features, and density of data; and generating the graph based on the updated weights.

According to exemplary embodiments, the process 600 may further include: implementing differentially private k-means or differentially private maximum mean discrepancy algorithm on the sampled data to compute the plurality of cluster centers.

According to exemplary embodiments, in the process 600, the machine learning model may include one or more of the following models: decision tree, ensemble trees, logistic regression, neural network architectures, and predictive model, but the disclosure is not limited thereto.

According to exemplary embodiments, the RPGD 402 may include a memory (e.g., a memory 106 as illustrated in FIG. 1) which may be a non-transitory computer readable medium that may be configured to store instructions for implementing a platform, language, database, and cloud agnostic RPGM 406 for automatically and dynamically generating realistic multi-step recourse paths with privacy guarantees as disclosed herein. The RPGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the RPGM 406 or within the RPGD 402, may be used to perform one or more of the methods and processes as described herein. In a particular embodiment, the instructions may reside completely, or at least partially, within the memory 106, the medium reader 112, and/or the processor 104 (see FIG. 1) during execution by the RPGD 402.

According to exemplary embodiments, the instructions, when executed, may cause a processor embedded within the RPGM 406 or the RPGD 402 to perform the following: receiving a first set of training data that is usable for training a machine learning model: training the machine learning model by using the at least the first set training data: implementing a data distribution sampling algorithm on the first set of training data to generate corresponding sampled data by partitioning the first set of training data into non-overlapping subsets with differentially private clustering: computing a plurality of cluster centers with differential privacy guarantees for each of said plurality of cluster centers: generating a graph that connects each cluster center with different weights between each cluster center; and automatically generating, for a data point that receives a negative outcome from the trained model, a recourse path with privacy guarantees based on a plurality of set points from the graph that provides shortest path to output a positive outcome. According to exemplary embodiments, the processor may be the same or similar to the processor 104 as illustrated in FIG. 1 or the processor embedded within the RPGD 202, RPGD 302, RPGD 402, and RPGM 406 which is the same or similar to the processor 104.

According to exemplary embodiments, the instructions, when executed, may cause the processor 104 to further perform the following: validating the generated recourse path by utilizing existing and new metrics, wherein the metrics include distance between points in the recourse path, density of points in the recourse path, and path length.

According to exemplary embodiments, in generating the graph, the instructions, when executed, may cause the processor 104 to further perform the following: connecting each cluster center: updating the weights to every other cluster based on distance threshold parameter, constraints for features, and density of data; and generating the graph based on the updated weights.

According to exemplary embodiments, the instructions, when executed, may cause the processor 104 to further perform the following: implementing differentially private k-means or differentially private maximum mean discrepancy algorithm on the sampled data to compute the plurality of cluster centers.

According to exemplary embodiments as disclosed above in FIGS. 1-6, technical improvements effected by the instant disclosure may include a platform for implementing a platform, language, database, and cloud agnostic recourse path generating module configured to implement an end-to-end differentially private pipeline for dynamically and automatically generating realistic counterfactuals and recourse paths, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating realistic multi-step recourse paths with privacy guarantees by utilizing one or more processors along with allocated memory and a machine learning model, the method comprising:
receiving a first set of training data that is usable for training a machine learning model;
training the machine learning model by using the at least the first set training data;
implementing a data distribution sampling algorithm on the first set of training data to generate corresponding sampled data by partitioning the first set of training data into non-overlapping subsets with differentially private clustering;
computing a plurality of cluster centers with differential privacy guarantees for each of said plurality of cluster centers;
generating a graph that connects each cluster center with different weights between each cluster center; and
automatically generating, for a data point that receives a negative outcome from the trained model, a recourse path with privacy guarantees based on a plurality of set points from the graph that provides shortest path to output a positive outcome.

2. The method according to claim 1, wherein the weights between each cluster center is defined by one or more of the following: distance thresholds between cluster centers, constraints specified for graph edges, and data density.

3. The method according to claim 2, wherein the plurality of cluster centers generated in the computing step represent a private version of the training data.

4. The method according to claim 1, further comprising:
validating the generated recourse path by utilizing existing and new metrics, wherein the metrics include distance between points in the recourse path, density of points in the recourse path, and path length.

5. The method according to claim 1, in generating the graph, the method further comprising:
connecting each cluster center;
updating the weights to every other cluster based on distance threshold parameter, constraints for features, and density of data; and
generating the graph based on the updated weights.

6. The method according to claim 1, further comprising:
implementing differentially private k-means or differentially private maximum mean discrepancy algorithm on the sampled data to compute the plurality of cluster centers.

7. The method according to claim 1, wherein the machine learning model includes one or more of the following models: decision tree, ensemble trees, logistic regression, neural network architectures, and predictive model.

8. A system for generating realistic multi-step recourse paths with privacy guarantees, the system comprising:
a processor; and
a memory operatively connected to the processor via a communication interface, the memory storing computer readable instructions, when executed, causes the processor to:
receive a first set of training data that is usable for training a machine learning model;
train the machine learning model by using the at least the first set training data;
implement a data distribution sampling algorithm on the first set of training data to generate corresponding sampled data by partitioning the first set of training data into non-overlapping subsets with differentially private clustering;
compute a plurality of cluster centers with differential privacy guarantees for each of said plurality of cluster centers;
generate a graph that connects each cluster center with different weights between each cluster center; and
automatically generate, for a data point that receives a negative outcome from the trained model, a recourse path with privacy guarantees based on a plurality of set points from the graph that provides shortest path to output a positive outcome.

9. The system according to claim 8, wherein the weights between each cluster center is defined by one or more of the following: distance thresholds between cluster centers, constraints specified for graph edges, and data density.

10. The system according to claim 9, wherein the plurality of cluster centers generated in the computing step represent a private version of the training data.

11. The system according to claim 8, wherein the processor is further configured to:
validate the generated recourse path by utilizing existing and new metrics, wherein the metrics include distance between points in the recourse path, density of points in the recourse path, and path length.

12. The system according to claim 8, in generating the graph, the processor is further configured to:
connect each cluster center;
update the weights to every other cluster based on distance threshold parameter, constraints for features, and density of data; and
generate the graph based on the updated weights.

13. The system according to claim 8, wherein the processor is further configured to:
implement differentially private k-means or differentially private maximum mean discrepancy algorithm on the sampled data to compute the plurality of cluster centers.

14. The system according to claim 8, wherein the machine learning model includes one or more of the following models: decision tree, ensemble trees, logistic regression, neural network architectures, and predictive model.

15. A non-transitory computer readable medium configured to store instructions for generating realistic multi-step recourse paths with privacy guarantees, the instructions, when executed, cause a processor to perform the following:
receiving a first set of training data that is usable for training a machine learning model;
training the machine learning model by using the at least the first set training data;
implementing a data distribution sampling algorithm on the first set of training data to generate corresponding sampled data by partitioning the first set of training data into non-overlapping subsets with differentially private clustering;
computing a plurality of cluster centers with differential privacy guarantees for each of said plurality of cluster centers;
generating a graph that connects each cluster center with different weights between each cluster center; and
automatically generating, for a data point that receives a negative outcome from the trained model, a recourse path with privacy guarantees based on a plurality of set points from the graph that provides shortest path to output a positive outcome.

16. The non-transitory computer readable medium according to claim 15, wherein the weights between each cluster center is defined by one or more of the following: distance thresholds between cluster centers, constraints specified for graph edges, and data density.

17. The non-transitory computer readable medium according to claim 16, wherein the plurality of cluster centers generated in the computing step represent a private version of the training data.

18. The non-transitory computer readable medium according to claim 15, wherein the instructions, when executed, cause the processor to further perform the following:
validating the generated recourse path by utilizing existing and new metrics, wherein the metrics include distance between points in the recourse path, density of points in the recourse path, and path length.

19. The non-transitory computer readable medium according to claim 15, in generating the graph, the instructions, when executed, cause the processor to further perform the following:
connecting each cluster center;
updating the weights to every other cluster based on distance threshold parameter, constraints for features, and density of data; and
generating the graph based on the updated weights.

20. The non-transitory computer readable medium according to claim 15, wherein the instructions, when executed, cause the processor to further perform the following:
implementing differentially private k-means or differentially private maximum mean discrepancy algorithm on the sampled data to compute the plurality of cluster centers.
